(19) United States
(12) Patent Application Publication
(10) Pub. No.: US 2012/0318787 A1
(43) Pub. Date: Dec. 20, 2012

(54) SYSTEM AND APPARATUS FOR SHIELDING A FLEXIBLE MICROWAVE PACKAGE

(76) Inventor: Maik Hach, Cape Girardeau, MO (US)

(21) Appl. No.: 13/163,389

(22) Filed: Jun. 17, 2011

(51) Int. Cl. H05B 6/80

(52) U.S. Cl. 219/725

(57) ABSTRACT

A system and apparatus for a flexible package are provided. The flexible package includes a first sealing layer, a first outer layer, and a first grid layer. The first grid layer includes a plurality of intersecting grid members formed of an electroconductive material surrounding a plurality of spaced apertures. The flexible package also includes a second sealing layer, a second outer layer, and a second grid layer. The second grid layer includes a plurality of intersecting grid members formed of an electroconductive material surrounding a plurality of spaced apertures. The grid members of the first grid layer are spaced apart from the grid members of the second grid layer such that electrical discharge between the first grid layer and the second grid layer is prevented when the flexible package is exposed to electromagnetic radiation in a microwave range.

### BACKGROUND OF THE INVENTION

The field of the invention relates generally to microwave packaging, and more specifically, to a flexible, laminate microwave package having a shielding grid layer for at least partially shielding electromagnetic radiation from a microwave oven to facilitate even product heating within the package.

To prepare a heated food, the microwave packaging, together with the food contained in it, has microwave energy applied to it in a microwave oven. Heating of the food occurs when the microwave energy from the microwave oven is absorbed by the moisture contained in the food.

Many foods that are desirable for heating in a microwave oven have an uneven thickness over an area of the food. For example, a chicken breast tends to be thicker towards a middle of the chicken breast and thinner near the edges. Accordingly, the chicken breast tends to heat unevenly though its thickness because portions of the chicken breast proximate an interior of the middle of the chicken breast receives less microwave energy and hence less heating than the portions near the surface and edges of the chicken breast. The surface portions of the chicken breast absorb a significant portion of the incident microwave energy such that the interior portions receive relatively little microwave energy.

Such uneven heating may produce a cool interior temperature and insufficient cooking of the food product while the surface and edges of the food are unpleasantly overcooked and dried-out. Accordingly, with existing technologies, certain food items cannot be readily prepared in a microwave oven. For example, large frozen food items, such as frozen lasagna that are cooked within a microwave oven typically result in the outside of the lasagna being overcooked and dried while the inside may be still frozen or relatively cold. Uneven shaped and frozen food items, such as chicken breast, cannot be readily prepared in a microwave oven because of having a thick center mass and thinner periphery. Additionally, food items that are cooked together that heat-up unevenly in a microwave oven, such as ready to eat meals or TV dinners, cannot be readily prepared in a microwave oven because some parts of the meal tend to become very hot, for example, the sauce, and other parts are still relatively cold, for example, the vegetable and/or dessert.

At least some known microwave packages attempt to employ a means for shielding at least some of the microwave energy applied by the microwave oven for cooking purposes. However, these known shielding packages fail to shield more than one side of the package, are not usable within a flexible package and fail to adequately address the problem of uneven heating of a food product within a microwave oven.

### BRIEF DESCRIPTION OF THE INVENTION

In one embodiment, a flexible package includes a front panel formed of a first sealing layer adjacent an interior of the flexible package, a first outer layer adjacent an exterior of the flexible package, and a first grid layer extending between the first sealing layer and the first outer layer. The first grid layer includes a plurality of intersecting grid members formed of an electroconductive material surrounding a plurality of spaced apertures. The flexible package also includes a back panel formed of a second sealing layer adjacent an interior of the flexible package, a second outer layer adjacent an exterior of the flexible package, and a second grid layer extending between the second sealing layer and the second outer layer, the second grid layer includes a plurality of intersecting grid members formed of an electroconductive material surrounding a plurality of spaced apertures, and a seal between adjacent edges of the front panel and the back panel. The grid members of the first grid layer are spaced apart from the grid members of the second grid layer such that electrical discharge between the first grid layer and the second grid layer is prevented when the flexible package is exposed to electromagnetic radiation in a microwave range.

In another embodiment, a microwave package formed of a flexible laminate includes a laminate structure including a plurality of compartments wherein the laminate structure includes a first sealing layer adjacent the interior volume of the microwave package, a first outer layer adjacent an exterior of the microwave package, and a first grid layer coupled to at least one of the first sealing layer and the first outer layer. The grid layer includes a plurality of grid members formed of an electroconductive material surrounding a plurality of spaced apertures. The microwave package also includes a laminate cover that includes a second sealing layer adjacent the interior volume of the microwave package, a second outer layer adjacent an exterior of the microwave package, and a second grid layer coupled to at least one of the second sealing layer and the second outer layer, the second grid layer includes a plurality of grid members formed of an electroconductive material surrounding a plurality of spaced apertures. The microwave package further includes a seal configured to join adjacent edges of the laminate structure and the laminate cover to form an interior volume sealable from the exterior of the microwave package. The grid members of the grid layer on the laminate structure are spaced apart from the grid members of the grid layer on the laminate cover such that electrical discharge between the laminate structure grid layer and the laminate cover grid layer is prevented when the flexible package is exposed to electromagnetic radiation in a microwave range.

In yet another embodiment, a microwave package formed of a flexible laminate includes a laminate structure surrounding an interior volume wherein the laminate structure includes a sealing layer adjacent the interior volume of the microwave package, a outer layer adjacent an exterior of the microwave package, and a grid layer extending between the sealing layer and the outer layer, the grid layer includes a plurality of grid members formed of an electroconductive material surrounding a plurality of spaced apertures. The microwave package also includes a seal configured to join adjacent edges of the laminate structure to form an interior volume sealable from the exterior of the microwave package. The grid members of the grid layer on a first side of the interior volume are spaced apart from the grid members of the grid layer on a second side of the interior volume opposite the first side such that electrical discharge between the grid layer and the grid layer is prevented when the flexible package is exposed to electromagnetic radiation in a microwave range.

### BRIEF DESCRIPTION OF THE DRAWINGS

FIGS. 1-8 show exemplary embodiments of the system and apparatus described herein.

FIG. 1 is a perspective view of a flexible package in accordance with an exemplary embodiment of the present invention;

FIG. 2 is a perspective view of the grid layer shown in FIG. 1 and a second grid layer in accordance with an exemplary embodiment of the present invention;

FIG. 3 is a side cross-sectional view of the front panel shown in FIG. 1 in accordance with an exemplary embodiment of the present invention;

FIG. 4 is a side cross-sectional view of the flexible package shown in FIG. 1 in accordance with an exemplary embodiment of the present invention;

FIG. 5 is a side cross-sectional view of flexible package shown in FIG. 1 in accordance with another exemplary embodiment of the present invention;

FIG. 6 is an exploded view of a complete meal microwavable package in accordance with an exemplary embodiment of the present invention;

FIG. 7 is a perspective view of a gusset-type flexible package bag in accordance with an exemplary embodiment of the present invention; and

FIG. 8 is a perspective view of the gusset-type flexible package bag illustrating bag in an open configuration.

### DETAILED DESCRIPTION OF THE INVENTION

The following detailed description illustrates embodiments of the invention by way of example and not by way of limitation. It is contemplated that the invention has general application to embodiments of shielding flexible microwave packages in industrial, commercial, and residential applications, such as, preheating industrial components and workpieces, sterilization and pasteurization processes, as well as home microwave food preparation.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

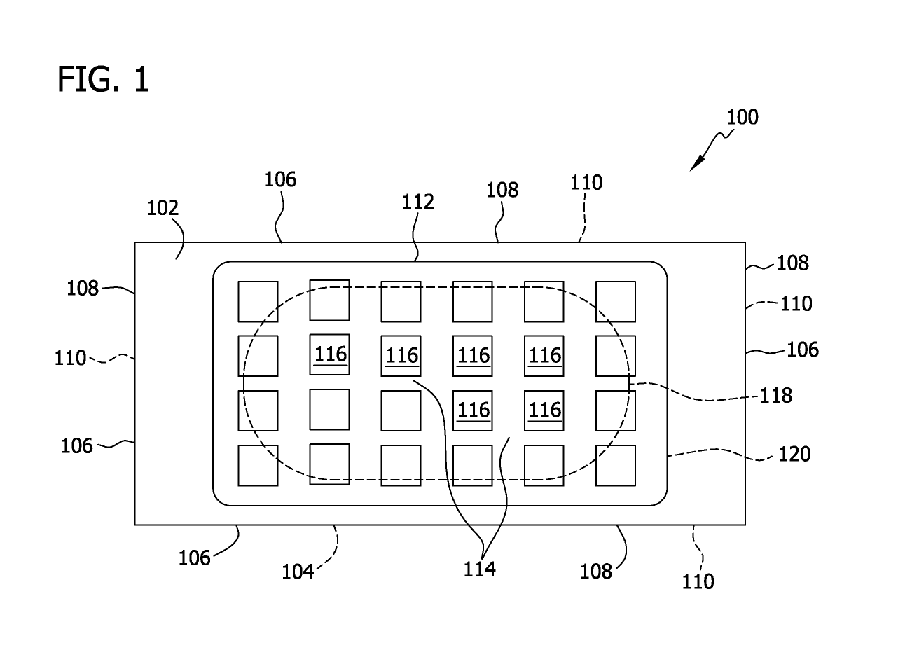

FIG. 1 is a front view of a flexible package 100 in accordance with an exemplary embodiment of the present invention. In the exemplary embodiment, flexible package 100 includes a front panel 102, an opposing back panel 104, and a seal 106 configured to couple edges 108 of front panel 102 to edges 110 of back panel 104. Front panel 102 includes a first grid layer 112 formed of a plurality of intersecting grid members 114 formed of an electroconductive material surrounding a plurality of spaced apertures 116. First grid layer 112 is sized and shaped to substantially cover an object, for example, but not limited to, a food item 118 contained within an interior volume (not shown in FIG. 1) of flexible package 100. Back panel 104 includes a second grid layer 120 (shown as a dashed line) that is configured similarly to first grid layer 112.

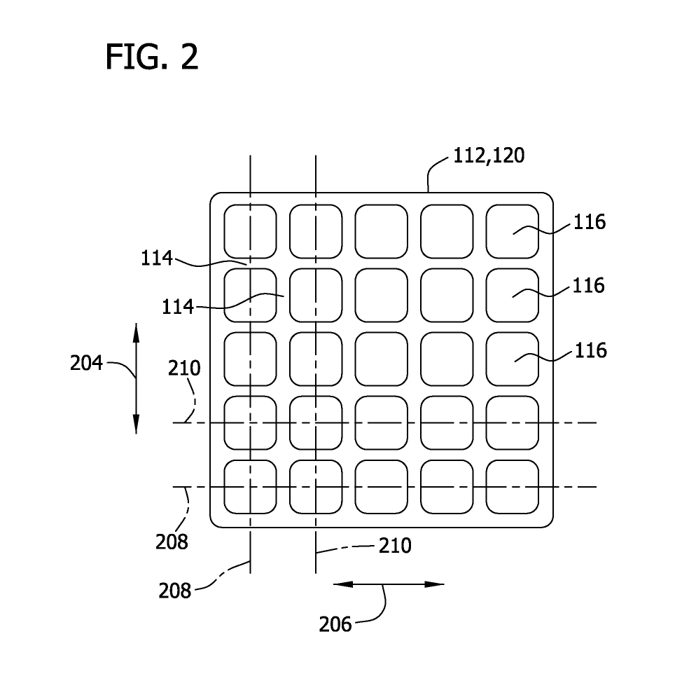

FIG. 2 is a plan view of either of grid layers 112 or 120 (shown in FIG. 1) in accordance with an exemplary embodiment of the present invention. In the exemplary embodiment, grid layers 112 and 120 are formed of a die-cut metal grid. In various embodiments, one or both of first grid layer 112 and second grid layer 120 may be formed of other materials, for example, but not limited to, metal inks printed on a substrate (not shown in FIG. 2). In the exemplary embodiment, first grid layer 112 and second grid layer 120 have a thickness ranging between approximately 2.0 and 20.0 μm and a height of approximately 130 mm in a lateral direction 204. First grid layer 112 and second grid layer 120 also have a width of approximately 130 mm in an axial direction 206. In other embodiments, first grid layer 112 and second grid layer 120 may be a different size and/or may be sized differently with respect to each other. For example, first grid layer 112 and/or second grid layer 120 may be sized to substantially match a profile or outline of food item 118 (shown in FIG. 1). Additionally, first grid layer 112 and/or second grid layer 120 may be sized larger than the profile or outline of food item 118 to account for possible shifting of food item 118 in flexible packaging 100 prior to heating. As such, first grid layer 112 and/or second grid layer 120 may have a different shape than square or rectangular. In various embodiments, an open area of grid layers 112 and 120, defined by apertures 116 is greater than approximately 50% of the total area of grids 112 and 120. Grid layers 112 and 120 have a cell size in a range of between approximately 100 mm² and approximately 900 mm², where the dimensions of a cell are measured from a centerline 208 of a first cell to a centerline 210 of a second cell in lateral direction 204 and axial direction 206. An area of grid layers 112 and 120 may be in a range of between approximately 900 mm² and approximately 90,000 mm². The areas represented are exemplary only and may be greater or smaller depending in part on the size of the microwave package and food item 118.

In the exemplary embodiment, intersecting grid members 114 are approximately 5.0 mm wide and aperture 116 openings are approximately 20.0 mm square. A measurement of an area of intersecting grid members 114 with respect to a measurement of an area of apertures 116 defines a grid coverage ratio. In the exemplary embodiment, the grid coverage ratio is constant in lateral direction 204 and an axial direction 206. In various embodiments, the grid coverage ratio varies in lateral direction 204 and/or an axial direction 206 typically to accommodate different thicknesses of food item 118. A greater grid coverage ratio is associated with less microwave energy reaching the portion of food item 118 adjacent the area of grid layer 112 and/or grid layer 120 having the greater grid coverage ratio. Similarly, a lesser grid coverage ratio is associated with more microwave energy reaching the portion of food item 118 adjacent the area of grid layer 112 and/or grid layer 120 having the lesser grid coverage ratio. Varying the grid coverage ratio permits variable heating of different areas of food item 118 while exposed to a similar microwave field inside an operating microwave oven.

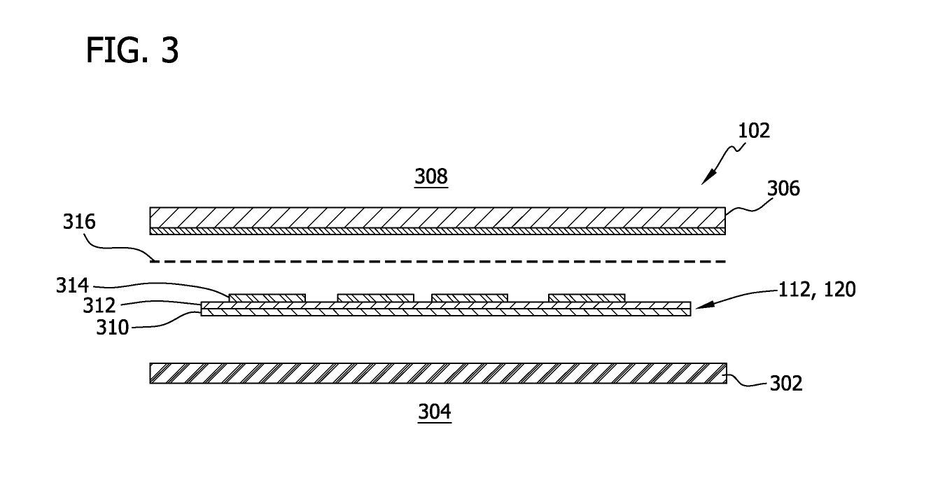

FIG. 3 is a side cross-sectional view of front panel 102 in accordance with an exemplary embodiment of the present invention. In one embodiment, back panel 104 is formed identically as front panel 102. In various embodiments, front panel 102 and back panel 104 are formed differently with respect to each other. In the exemplary embodiment, front panel 102 includes a first sealing layer 302 adjacent an interior volume 304 of a flexible package formed using front panel 102. Front panel 102 also includes a first outer layer 306 adjacent an exterior 308 of the flexible package. Grid layers 112 or 120 are sandwiched between first sealing layer 302 and first outer layer 306. In one embodiment, grid layer 112 or 120 are formed of a die-cut metal foil. In various other embodiments, grid layer 112 or 120 are formed of a metal ink printed on a substrate.

First sealing layer 302 may comprise one or more layers of polyolefin (PO), or other suitable moisture impermeable film such as, but not limited to, polyethylene (PE), polyamide (PA), polypropylene (PP), or combinations thereof. In the exemplary embodiment, first sealing layer 302 has a thickness of approximately 20-200 μm. First outer layer 306 may comprise one or more layers of polyester (PET), bi-axially oriented polypropylene (BOPP), polyamide (PA), biaxially oriented nylon (BON), polyethylene (PE), polypropylene (PP), non oriented PP, cellophane, paper substrate, or combinations thereof. Grid layers 112 or 120 may include a pressure sensitive adhesive (PSA) layer 310, and a metal grid layer 314. In various embodiments, grid layers 112 or 120 may also include a carrier layer 312 to facilitate handling and processing. Prior to assembly of front panel 102 a release layer (not shown) may be used with die-cut metal foil grid layer 112 or 120 to facilitate handling. Such a release layer may be formed of, for example, PET, BOPP, or paper. During assembly, a polyurethane (PUR) adhesive layer 316 may be used to secure first outer layer 306 to grid layer 112 or 120 and first sealing layer 302.

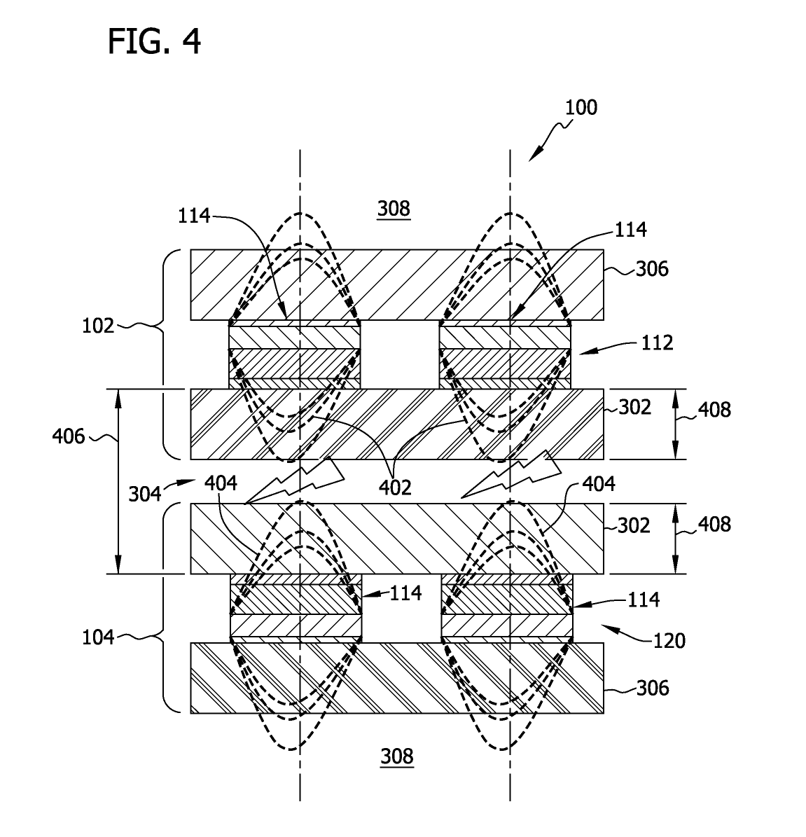

FIG. 4 is a side cross-sectional view of flexible package 100 (shown in FIG. 1) in accordance with an exemplary embodiment of the present invention. In the exemplary embodiment, grid members 114 of grid layer 112 and grid layer 120 are aligned directly across interior volume from each other. During heating, microwave energy is applied to flexible package 100 and consequently to grid members 114, which in turn generate their own electromagnetic field fields 402 and 404. If electromagnetic field fields 402 and 404 are strong enough, an interaction between electromagnetic field fields 402 and 404 may cause arcing within flexible package 100 and/or interior volume 304. Such arcing may cause melting of flexible package 100, generation of unpleasant smelling and/or tasting odors and residue that can detrimentally affect food item 118. To reduce and/or eliminate such arcing, a minimum distance 406 between respective grid members 114 of grid layer 112 and grid layer 120 is maintained. In the exemplary embodiment, distance 406 is maintained in a range of between approximately 250.0 μm and approximately 750.0 μm. In various embodiments, distance 406 is maintained in a range of between approximately 450.0 μm and approximately 600.0 μm. Factors in selecting distance 406 include a size of grid layers 112 and 120, grid members 114 and apertures 116, and a shape of grid members 114 and apertures 116. For example, more rounded corners of apertures 116 or elimination of corners in apertures 116 facilitates reducing a tendency of grid layers 112 and 120 to generate an arc between them and therefore distance 406 may be selected to be smaller. In one embodiment, distance 406 is maintained by providing a minimum thickness 408 for sealing layer 302 of front panel 102 and/or for sealing layer 302 of back panel 104. In the exemplary embodiment, distance 406 of greater than 0.5 mm is maintained by maintaining thickness 408 greater than approximately 250.0 μm and in another embodiment thickness 408 is maintained greater than approximately 300.0 μm. Such a thickness may be maintained, for example, by providing sealing layer 302 of front panel 102 and/or back panel 104 as a foamed film having an open-pore or closed-pore structure. Moreover, sealing layer 302 may be formed of a film having an embossed surface, a film having a textured surface, a film having a corrugated surface, or a film having its thickness increased by mechanical means or by additions of material to the bulk film material. In addition to the inner sealing layers 302 of front panel 102 and back panel 104 providing a spacing between the electroconductive grid of front panel 102 and back panel 104, a gusseted bag-type package further prevents front panel 102 and back panel 104 from coming into such close proximity with respect to each other that arcing may be generated.

In various other embodiments, arcing is reduced by increasing a content of a dielectric material within or coupled to a surface of sealing layer 302. In one embodiment, migratory antistatic components are used. In other embodiments, non-migratory antistatic components are used. The non-migratory antistatic components are based on polymeric antistatic chemistry, which does not depend on atmospheric humidity for functioning. The antistatic component additive forms an interconnecting or percolating network and dissipation of the charge building on the surface of sealing layer 302. Moreover, polar polymer and polymer blends are used within sealing layer 302 to facilitate dissipating charge and reducing arcing. In addition, ceramic particles, for example, but not limited to, barium titanate (BaTiO₃) and titanium dioxide (TiO₂) may be blended into the polymer matrix of sealing layers 302.

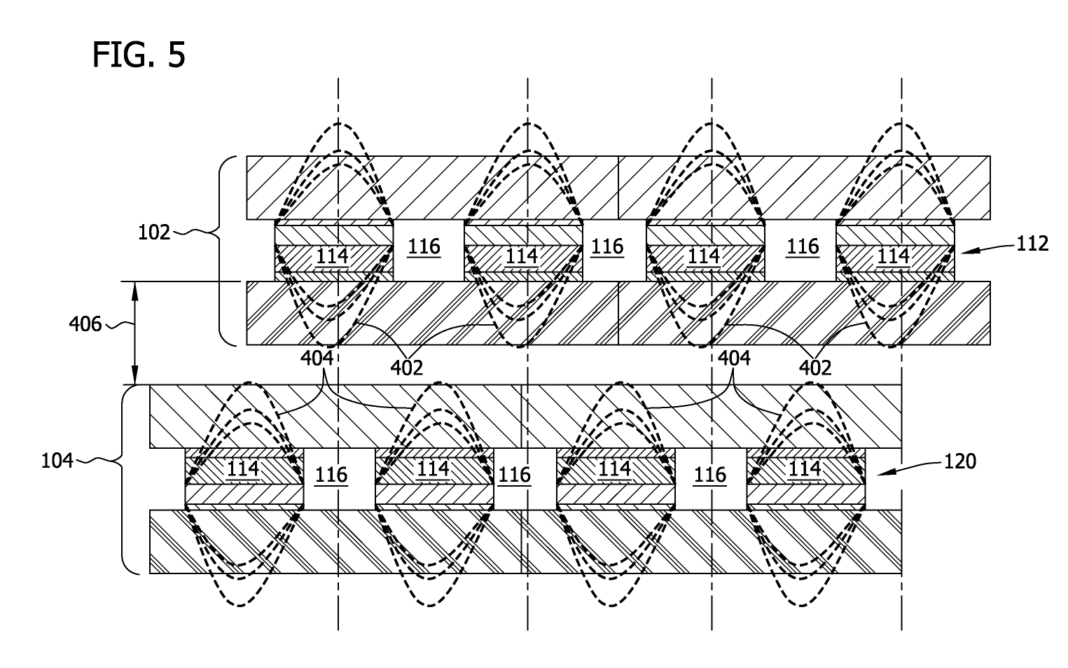

FIG. 5 is a side cross-sectional view of flexible package 100 (shown in FIG. 1) in accordance with another exemplary embodiment of the present invention. In the exemplary embodiment, grid members 114 of grid layer 112 and grid layer 120 are aligned offset with respect to each other. In the exemplary embodiment of FIG. 5, distance 406 is maintained by aligning grid members 114 of front panel 102 offset with respect to grid members 114 of back panel 104. In the exemplary embodiment, the offset is approximately equal to the pitch of grid members 114 such that grid members 114 of front panel 102 are aligned with respective apertures 116 of back panel 104 and grid members 114 of back panel 104 are aligned with respective apertures 116 of front panel 102.

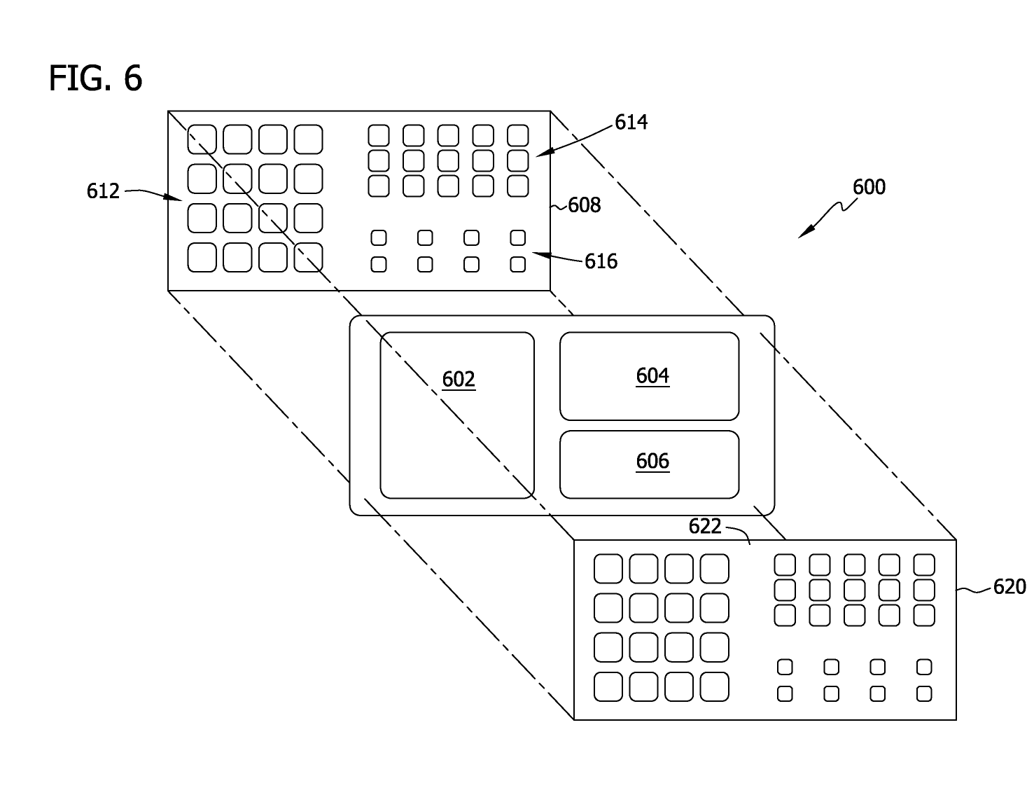

FIG. 6 is an exploded view of a complete meal microwavable package 600 in accordance with an exemplary embodiment of the present invention. In the exemplary embodiment, a first portion 601 of package 600 is divided into compartments, such as, but not limited to, an entrée compartment 602, a side dish compartment 604, and a dessert compartment 606. First portion 601 also includes a grid layer 608 that covers at least a portion of first portion 601. In one embodiment, grid layer 608 is coupled to an underside of first portion 601. In various embodiments, grid layer 608 is coupled to an inside surface of first portion 601. Grid layer 608 includes a plurality of areas 612, 614, and 616, which correspond to the compartments of first portion 601. Areas 612, 614, and 616 include grid members and apertures that define a microwave coverage ratio for each area. In some embodiments, the microwave coverage ratio for each area is predetermined based on a food item to be contained within each compartment. Various food types may have different heatability characteristics in a microwave field and may also have different heating requirements to reach a desired temperature or level of complete heating. For example, an entrée food item that includes gravy may heat relatively easily compared to a vegetable. Therefore, a grid coverage ratio for entrée compartment 602 may be greater than for side dish compartment 604. However, the entrée item may be thicker or unevenly shaped, which may dictate that grid coverage ratio be less than if the heatability characteristics were taken alone. As used herein, heatability refers to an ability of an object to convert microwave energy into thermal energy measured generally in units of temperature. The heatability is related to a concentration of hydrogen within the object and the thickness of the object.

Package 600 also includes a cover 620 that includes a grid layer 622 configured similarly to grid layer 608. During heating, an amount of microwave energy reaching each separate food item in each compartment may be selected by a predetermined microwave coverage ratio controlled by a relative size of grid members and apertures in grid layer 608 and/or grid layer 622. By controlling the amount of microwave energy reaching each individual food item in the compartments, optimal heating can occur.

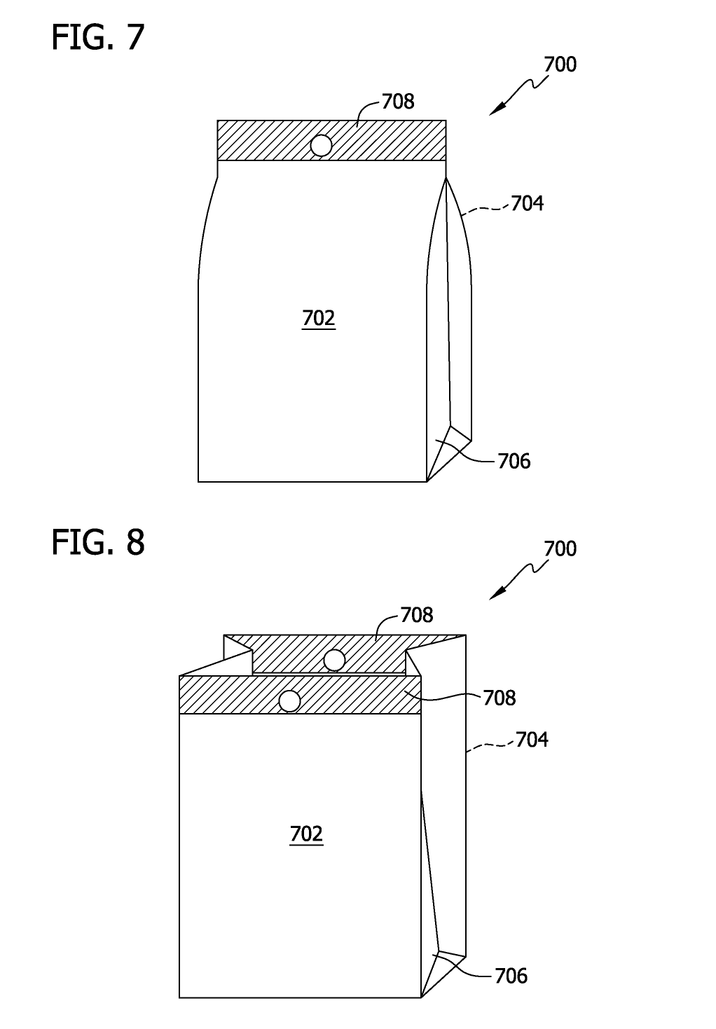

In various embodiments, flexible package 100 may be formed in a number of package or bag configurations, for example, a pillow-type package (shown in FIG. 1) and a gusset bag (shown in FIG. 7) having a flat bottom. Accordingly, seal 106 may be formed appropriately depending on the packaging style, for example, a heat-sealed seam or a pleated sidewall.

FIG. 7 is a perspective view of a gusset-type flexible package bag 700 in accordance with an exemplary embodiment of the present invention. FIG. 8 is a perspective view of gusset-type flexible package bag 700 illustrating bag 700 in an open configuration. In the exemplary embodiment, bag 700 includes a laminate front panel 702, a laminate back panel 704, and a seal 706 extending between front panel 702 and back panel 704. Bag 700 also includes an opening seal 708 that may be formed by heat-sealing front panel 702 to back panel 704. Additionally, opening seal 708 may include a re-sealable seal using for example, a plastic zipper, adhesive, or other re-sealable device. An opening 710 permits filling bag 700 with a food product (not shown in FIGS. 7 and 8) after bag 700 is formed. In the exemplary embodiment, laminate front panel 702 and laminate back panel 704 are formed of layers including an electroconductive grid (as described above) sealed between an inner sealing layer and an outer layer, which may include printing and/or designs. In addition to the inner sealing layers of front panel 702 and back panel 704 providing a spacing between the electroconductive grid of front panel 702 and back panel 704, the gusseted seal 706 further prevents front panel 702 and back panel 704 from coming into such close proximity with respect to each other, which could permit arcing to be generated.

The above-described embodiments of a system and apparatus for shielding a flexible microwave package provides a cost-effective and reliable means for improving of food quality due to a reduced moisture loss, reducing of surface sogginess of breaded food items, improving of heat distribution of uneven shaped and large food items, and enhancing the microwave preparation of complete ready-to eat meals. More specifically, the system and apparatus described herein facilitate controlled microwave shielding for microwavable packages having flexible sides, bottom and/or top. As a result, the system and apparatus described herein facilitate a heating preparation of food items in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A flexible package comprising:
a front panel formed of a first sealing layer adjacent an interior of said flexible package, a first outer layer adjacent an exterior of said flexible package, and a first grid layer extending between said first sealing layer and said first outer layer, said first grid layer comprising a plurality of intersecting grid members formed of an electroconductive material surrounding a plurality of spaced apertures;
a back panel formed of a second sealing layer adjacent an interior of said flexible package, a second outer layer adjacent an exterior of said flexible package, and a second grid layer extending between said second sealing layer and said second outer layer, said second grid layer comprising a plurality of intersecting grid members formed of an electroconductive material surrounding a plurality of spaced apertures; and
a seal between adjacent edges of said front panel and said back panel, where
said grid members of said first grid layer are spaced apart from said grid members of said second grid layer such that electrical discharge between said first grid layer and said second grid layer is prevented when said flexible package is exposed to electromagnetic radiation in a microwave range.

2. A flexible package in accordance with claim 1, wherein said intersecting grid members of said first grid layer are offset with respect to said intersecting grid members of said second grid layer.

3. A flexible package in accordance with claim 1, wherein an outer periphery of at least one of said first grid layer and said second grid layer approximately matches an outline of a food item contained with said flexible package.

4. A flexible package in accordance with claim 1, wherein an outer periphery of at least one of said first grid layer and said second grid layer extends beyond an outline of a food item contained with said flexible package by a predetermined distance.

5. A flexible package in accordance with claim 1, wherein a measurement of an area of said intersecting grid members with respect to a measurement of an area of said plurality of spaced apertures defines a grid coverage ratio, where the grid coverage ratio of at least one of said first grid layer and said second grid layer varies along at least one of a length and a width of a food item contained with said flexible package.

6. A flexible package in accordance with claim 5, wherein the grid coverage ratio of at least one of said first grid layer and said second grid layer is greater than approximately 50%.

7. A flexible package in accordance with claim 1, wherein said flexible package comprises a pillow-type package and said seal comprises a heat-sealed seam.

8. A flexible package in accordance with claim 1, wherein said flexible package comprises a gusset-type bag and said seal comprises a pleated sidewall.

9. A flexible package in accordance with claim 1, wherein at least one of said first sealing layer and said second sealing layer comprises ceramic particles.

10. A flexible package in accordance with claim 1, wherein at least one of said first sealing layer and said second sealing layer comprises a predetermined thickness selected to prevent arcing between said first grid layer and said second grid layer when said flexible package is exposed to electromagnetic radiation in a microwave range.

11. A flexible package in accordance with claim 1, wherein at least one of said first sealing layer and said second sealing layer comprises at least one of a foamed film, a film having an embossed surface, a film having a textured surface, and a film having a corrugated surface.

12. A microwave package formed of a flexible laminate, said package comprising:
a laminate structure comprising a plurality of compartments, said laminate structure comprising:
a first sealing layer adjacent an interior volume of said microwave package;
a first outer layer adjacent an exterior of said microwave package; and
a first grid layer coupled to at least one of said first sealing layer and said first outer layer, said grid layer comprising a plurality of grid members formed of an electroconductive material surrounding a plurality of spaced apertures;
a laminate cover comprising:
a second sealing layer adjacent the interior volume of said microwave package;
a second outer layer adjacent the exterior of said microwave package; and
a second grid layer coupled to at least one of said second sealing layer and said second outer layer, said second grid layer comprising a plurality of grid members formed of an electroconductive material surrounding a plurality of spaced apertures; and
a seal configured to join adjacent edges of said laminate structure and said laminate cover to define the interior volume sealable from the exterior of said microwave package, where
said grid members of said first grid layer are spaced apart from said grid members of said second grid layer such that electrical discharge between said first grid layer and said second grid layer is prevented when said flexible package is exposed to electromagnetic radiation in a microwave range.

13. A flexible package in accordance with claim 12, wherein a measurement of an area of said intersecting grid members with respect to a measurement of an area of said plurality of spaced apertures defines a grid coverage ratio, where the grid coverage ratio of at least one of said first grid layer and said second grid layer varies among said plurality of compartments contained with said flexible package.

14. A flexible package in accordance with claim 12, wherein a measurement of an area of said intersecting grid members with respect to a measurement of an area of said plurality of spaced apertures defines a grid coverage ratio and wherein the grid coverage ratio of at least one of said first grid layer and said second grid layer varies along at least one of a length and a width of a food item contained within one of the plurality of compartments said laminate structure.

15. A flexible package in accordance with claim 12, wherein grid members of said grid layer on said laminate structure are spaced apart from said grid members of said grid layer on said laminate cover using a predetermined thickness of at least one of said first sealing layer and said second sealing layer.

16. A microwave package formed of a flexible laminate, said package comprising:
a laminate structure surrounding an interior volume, said laminate structure comprising:
a sealing layer adjacent the interior volume of said microwave package;
an outer layer adjacent an exterior of said microwave package; and
a grid layer extending between said sealing layer and said outer layer, said grid layer comprising a plurality of grid members formed of an electroconductive material surrounding a plurality of spaced apertures; and
a seal configured to join adjacent edges of said laminate structure to define the interior volume sealable from the exterior of said microwave package, where
said grid members of said grid layer on a first side of the interior volume are spaced apart from said grid members of said grid layer on a second side of the interior volume opposite the first side such that electrical discharge between said grid layer and said grid layer is prevented when said flexible package is exposed to electromagnetic radiation in a microwave range.

17. A flexible package in accordance with claim 16, wherein said sealing layer comprises a polymer film and a dielectric additive.

18. A flexible package in accordance with claim 16, wherein an outer periphery of said grid layer on at least one of the first side and the second side approximately matches an outline of a food item contained with said flexible package.

19. A flexible package in accordance with claim 16, wherein a measurement of an area of said intersecting grid members with respect to a measurement of an area of said plurality of spaced apertures defines a grid coverage ratio, where the grid coverage ratio of at least one of said first grid layer and said second grid layer varies along at least one of a length and a width of a food item contained with said flexible package.

20. A flexible package in accordance with claim 16, wherein said sealing layer comprises a foamed film having a predetermined thickness selected to prevent arcing between said first grid layer and said second grid layer when said flexible package is exposed to microwave electromagnetic radiation.
